(19) United States
(12) Patent Application Publication
(10) Pub. No.: US 2002/0184095 A1
(43) Pub. Date: Dec. 5, 2002

(54) Automatic building and categorization of favorites in an internet browser

(75) Inventors: Rand Scullard, New York, NY (US); Mordechai Beizer, Scarsdale, NY (US); Mark Solomon, North Massapequa, NY (US); Carl Gutowski, Wappingers Falls, NY (US)

Correspondence Address: DARBY & DARBY P.C., 805 Third Avenue, New York, NY, 10022, US

(73) Assignee: CERTRA, INC.

(21) Appl. No.: 09/875,368

(22) Filed: Jun. 5, 2001

(51) Int. Cl. G06F 17/60

(52) U.S. Cl. 705/14; 705/27

(57) ABSTRACT

A method of automatically creating “Favorites” or “Book Marks” in an Internet web browser involves monitoring the browser and producing a bookmark indication if it is (1) communicating with a web site and (2) it is being used in a predefined pattern of activity at the web site. When these conditions are met, the universal resource locator (URL) of the web site is captured in response to the bookmark indication. The URL is then stored in the Favorites list of the browser. An identifying title is also stored with the URL in the Favorites list. In one embodiment, the method further includes compiling a database of URLs and categories of information to which the URLs related. Then the captured URL is compared to the database to determine a category for the URL so that it is stored in the Favorites list in a folder identified with the category.

This invention relates to internet browsers and, more particularly, to bookmarks and “Favorites” lists in internet browsers.

The use of the internet to locate and exchange information, as well as to shop for items of interest, is now well established. In a typical configuration, which enables retail shopping, the customer has a personal computer 10 with a telephone or other connection through the Internet as shown in FIG. 1. The customer's computer 10 establishes a connection through the Internet 20 to a web site 30 maintained by a merchant with products to sell, for example, Amazon.com. The connection is managed by browser software 12 stored in a memory 14 on the customer's computer 10.

The customer is connected to a webserver 32 at the merchant's website 30, which allows the customer to view HTML documents in the form of web pages. These pages, for example, are product details, a shopping cart or other product information which is stored in a database or part of a database 36. The customer from his computer 10 is in interactive communication with a program 44 at the website which controls access to the HTML web pages. This program further stores information from and about the customer in a database or part of a database 48. The customer's shopping selections, which can be based on choices the customer makes from viewing the product web pages, are similarly stored in a database 52.

In some cases the customer does not go directly over the Internet to the merchant web site, but instead visits another web site 40 which is associated with the merchant web site. For example, if website 30 is a book seller, e.g. Amazon.com, web site 40 may be the site of a reviewer of children's books. This site 40 has its own web server 70 and collection of HTML web pages in a database 72. The pages at the associate web site 40 may be provided with a hypertext link which the user can click on to purchase one of the books being reviewed. This would connect the customer to the merchant website 30.

In one business model, the link has an identification code in it which indicates to the merchant site 30 that the customer has been connected to the site from the associate web site. This information may be stored in a database or portion of a database, 60. By agreement, the merchant may pay the associate a flat fee for directing the customer to the web site or may pay the associate a percentage of the revenue generated if the customer makes a purchase. The details of such an associate system are shown in U.S. Pat. No. 6,029,141 of Bezos et al. (the entirety of which is incorporated herein by reference).

As shown in FIG. 2, the browser 12 displays a graphical user interface. Address line 100 of the interface allows the universal resource locator (URL) of the desired website to be entered, for example, www.amazon.com. This causes the software on the computer 10 to connect to Amazon's server 32 over the Internet as shown in FIG. 3. While this connection is maintained, the customer can use the browser to explore the database of web pages at the website, which contains descriptions of various items being sold by the retailer maintaining the web server. As shown in FIG. 3, this includes books, electronics, music, etc.

As a standard feature, which will allow this website to be memorized by the browser, the URL for the website can be “bookmarked”. In the browser shown in FIG. 3, which is a Microsoft Internet Explorer browser, this is done by clicking on the Favorites command 102 on the toolbar, which results in the screen shown in FIG. 4. This screen has a portion 104 on the left hand side that has a title line 106, i.e. “Favorites”. Under the title line there are two choices 108, i.e. Add and Organize. Below the choices 108 are a list of folders and file icons. The file icons, e.g. MSN 109, indicate links to websites (e.g. Microsoft Network) that can be activated by clicking on the icon. As a result, the URL for the site does not have to be recalled and entered in the address bar 100. The folders, e.g. the Media Folder 110, will display a list of file icons which have been characterized as Media as shown in FIG. 5. Each file in the folder is a link to a specific web site.

By clicking on “Add” in the choice line 108, the URL for this website can be added to the Favorites list. A pop-up dialog box 112 as shown in FIG. 6 provides an indication of the name under which the favorite will be stored, e.g. “Amazon.com-Earth's Biggest Selection”. By clicking on “Create In” in box 112, a selection of categories or folders 114 is provided for the favorites in which the particular website can be stored as shown in FIG. 7. If a new folder or category is to be created, the New Folder button is clicked. This causes the display of a popup dialog box 116 as shown in FIG. 8, in which a new folder can be created.

As an alternative, a new folder can be created by clicking on the Organize button on the choice line 108 in FIG. 5. The result is the dialog box 118 as shown in FIG. 9. This box can be used to create a folder, rename it or delete it. Further, a favorites file can be renamed, moved to a folder or deleted.

The result of bookmarking the Amazon.com site is shown in FIG. 10 as file 120. Whenever the favorites button is clicked and the list of favorites is displayed, the recent addition of Amazon.com is in the list. Thus, when the web browser is first started, if a customer wishes to go to the Amazon.com website, all they need to do is click on Favorites and then click on Amazon.com in the list that is provided.

Another way a user can return to a site previously visited is by clicking on the History button 122 on the toolbar. This causes a history list 130 to appear on the left side of the screen in the area formerly occupied by the Favorites list is shown in FIG. 11. By selecting an icon, the user can see the list of every site visited in the last 3 weeks, 2 weeks, week or day of the week. However, the sites are simply listed alphabetically within each chronological grouping, so it is not easy for a shopper to use.

As can be seen from the foregoing, the process of creating bookmarks or favorites is very user intensive. In particular, the user must decide that this a site which is to be bookmarked. Then, the user actually has to go through the steps of creating the bookmark as a favorite. If the user has bookmarked a large number of sites, they would eventually no longer fit on the screen. Thus, the user has to manually create categories or folders and associate any particular bookmarked location with a folder. While the history list does not require this kind of effort by the user, it imposes no organizational structure to the sites visited, and so is not very helpful to a shopper.

Because the prior art techniques for creating a favorite link requires a large amount of user intervention and thought, it is very frequent that a user will forgo or forget to bookmark a site. Then, when the user wants to return to the site, they essentially have to use traditional methods to locate the site again. For example, they may have to click on the Search toolbar button and then enter search terms, get a list of search results, and then find the correct one which leads to the site that they are interested in. Thus, it would very advantageous if the sites of interest, as demonstrated by the user access to those sites, were automatically built up as a list. Further, even more utility could be achieved if the sites in the list were set into categories or folders automatically.

### SUMMARY OF THE INVENTION

The present invention is directed to automatically building, and perhaps categorizing bookmarks to favorite websites. The result of such a process is to automatically create a list of websites that have been implicitly designated as important, e.g. by the types of sites, the frequency with which the user visits those sites, or the activities conducted by the user at those sites.

In an illustrative embodiment of the invention an Internet web browser is provided with additional functionality, for example, by way of a “plug-in” which allows the automatic building of Favorites. For example, the software adds to a list of favorites every site that the user has visited where the user has engaged on a designated activity. To accomplish this according to the invention, the user's activity is monitored by software whenever a site is entered. The software looks for particular patterns of activity at this site to indicate that a bookmark should be created. As an example, bookmarking can be affected automatically only for a retail website. As an additional filter, bookmarking can be made to occur only when the pattern of activity indicates that the user is making, or has made, a purchase at that particular website.

As disclosed in co-pending U.S. Provisional Patent Application No. 60/206,552, which is hereby incorporated in its entirety by reference, MaxManager software is available for determining a purchasing pattern on a number of retail websites. This software is readily available at www.maxmanager.com. With MaxManager software, whenever a purchase pattern of action is detected, a purchase determination form appears. Information from the website is used to populate most of the fields of the form, but others are filled out by the user. The purpose of this software is to keep a history of purchases made on the Internet and to be able to keep track of the progress of such purchases and their delivery. However, the user's act of filling out the purchase determination form also tells the software according to the present invention that the current website is of potentially great future interest to this user, and thus the software can automatically save the URL as a Favorite in a category or folder containing merchant sites of interest to the user. Since MaxManager includes a database of merchants where each merchant is associated with one or more categories of goods or services, the software according to the present invention can automatically place the bookmark in an appropriate category or folder.

If a user is at a site which does not automatically recognize the MaxManager pattern of activity, the purchase determination form can be invoked by pressing on an icon, which is incorporated into the web browser. This brings up the same form which was invoked automatically at supported websites. This form can be filled out manually. The result with the present invention is that the site will automatically be inserted in the Favorites list under the category or folder containing merchant sites of interest to the user.

Furthermore, with the present invention it is not necessary that the user actually complete a purchase at a merchant web site. In many cases, a visit by the user to a merchant web site is sufficient to indicate that the user has an interest in future shopping visits to that site. The MaxManager software can detect a visit to a site in its merchant directory, even without invocation of the purchase determination form. Therefore, according to the present invention the site will, upon the user's visit to the site, automatically be inserted in the Favorites list under the category or folder containing merchant sites of interest to the user.

Since it is possible that the user will visit many sites of a particular category over time, in the preferred embodiment of the invention there is a mechanism for preventing the list of sites in any category from growing too large for easy access by the user. One way to implement this is to set a maximum number of sites per category, and have the software automatically discard the oldest (least-recently-accessed) site from a category when that number is exceeded. Another way is to have the software provide some user interface whereby the user can indicate which sites are of greatest interest, allowing the software to automatically discard other sites as the list grows too long.

During the process of selecting an item to purchase, shoppers typically want to visit multiple sites where that type of item is available, to collect information and do comparison shopping. Users like to be informed of sites they were not aware of, if these sites are relevant to the user's current task. Therefore, the present invention includes the capability of presenting the user with site recommendations in conjunction with the list of sites they have visited in a given category. For example, if the user is viewing the automatically-generated list of bookmarks to music merchants, there can also be a set of recommended music merchants presented along with the bookmarks. In the preferred embodiment of the invention, the recommended sites are visually differentiated from sites that the user has actually visited, for example by use of a different icon in the bookmark.

It should be noted, however, that the present invention is not limited to use of the MaxManager software. In essence, the invention merely requires some software capable of recognizing some general pattern of activity of the user at the website, which indicates that that website should be added to the Favorites list. Thus, any database of websites and triggering activities can be used to automatically perform storage of the site's URL as a Favorites. Further, if the database has categories associated with the sites, the saving of the URL can be categorized and the URL stored in a related folder. A categorization scheme can also be constructed where a single given site can be filed under multiple categories or folders (for example, a site related to both books and music could be filed under each of those categories). Also, any pattern of activity can be used to indicate that the user has interest in the site, and thus it should be bookmarked. This may be nothing more than, for example, clicking on a list displayed at the website or moving to more than one or two pages of the screen at the website.

### BRIEF DESCRIPTION OF THE DRAWINGS

The foregoing and other features of the present invention will be more readily apparent from the following detailed description and drawings of illustrative embodiments of the invention in which:

FIG. 1 is a schematic diagram of a client-server interconnection over the Internet as used in the prior art;

FIG. 2 is an illustrative example of a screen display of a prior art web browser;

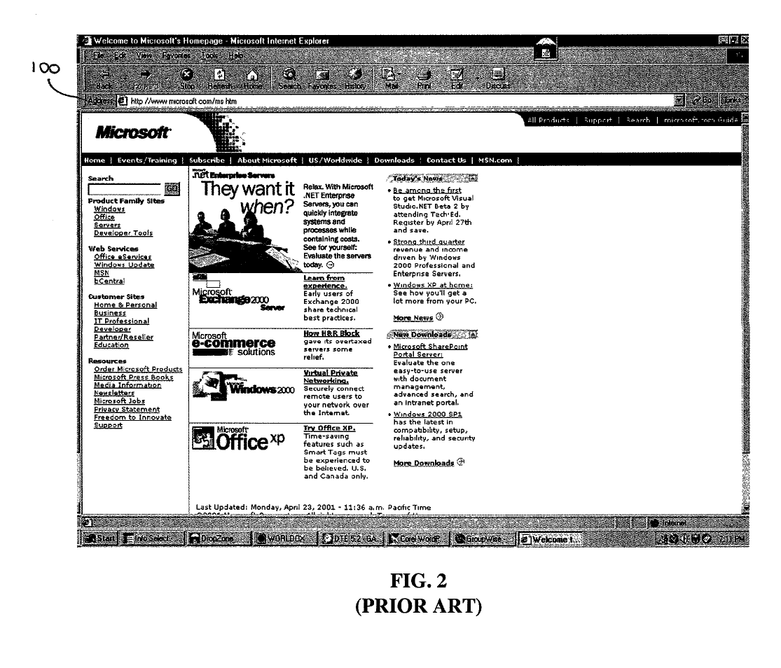

FIG. 3 is an illustration of the web browser screen of FIG. 2 at the website of a retailer;

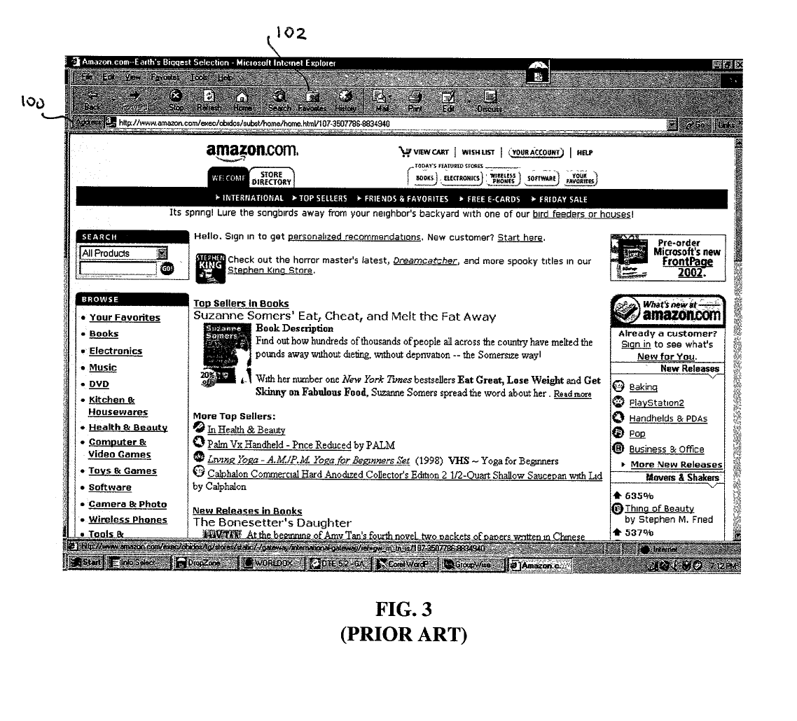

FIG. 4 shows the prior art web browser screen of FIG. 2 with the Favorites window invoked;

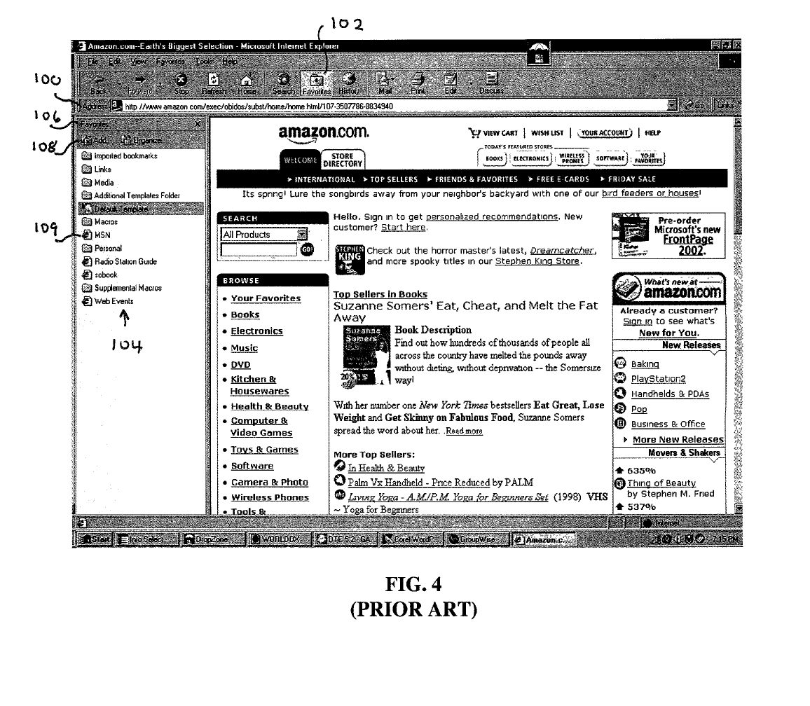

FIG. 5 illustrates the prior art web browser screen of FIG. 4 with a folder invoked;

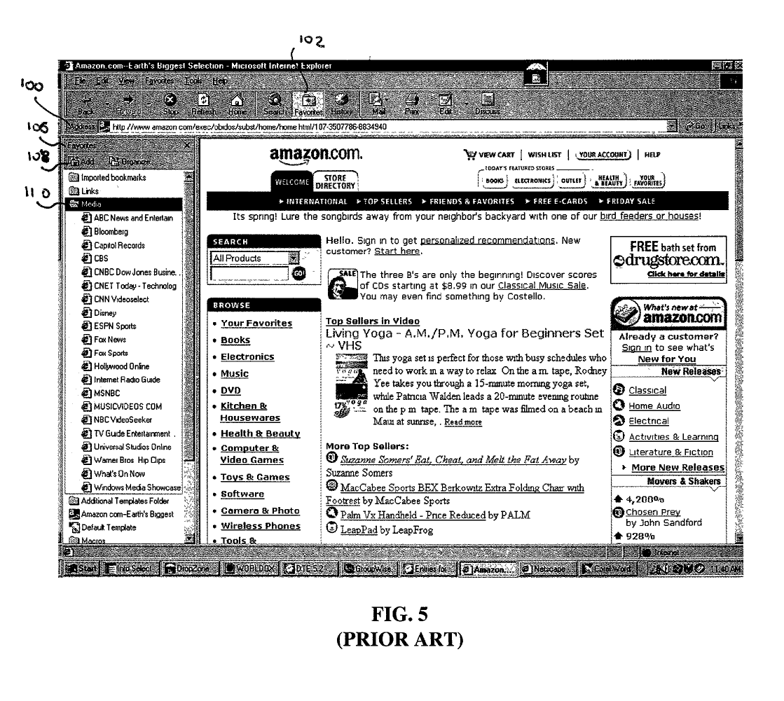

FIG. 6 illustrates the prior art web browser screen of FIG. 5 with the “Add . . .” button activated to invoke a popup dialog box;

FIG. 7 shows the prior art web browser screen of FIG. 6 with the “Create in . . .” button activated to invoke a popup dialog box showing available categories in which a favorite can be saved;

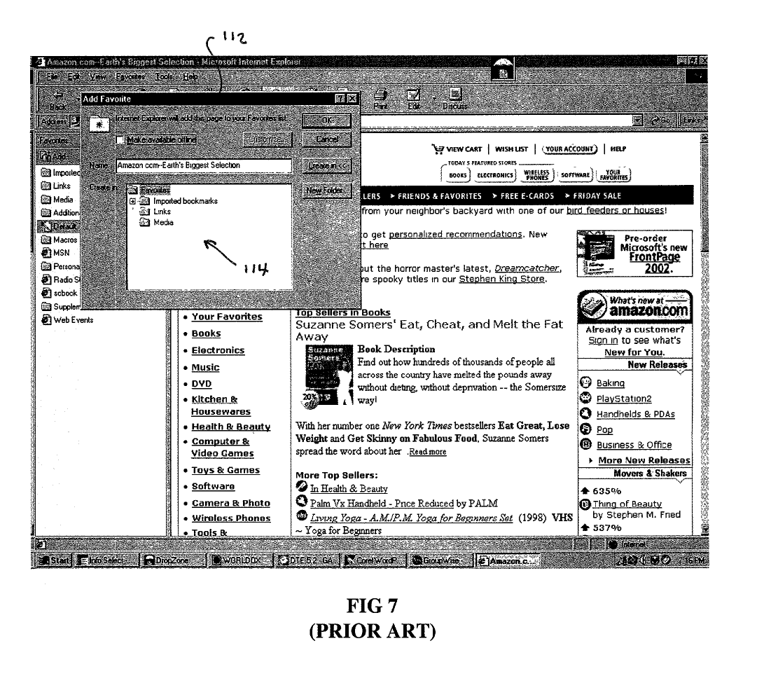

FIG. 8 shows the prior art web browser screen with the “New Folder . . .” button of the dialog box of FIG. 7 invoked to display an additional dialog box;

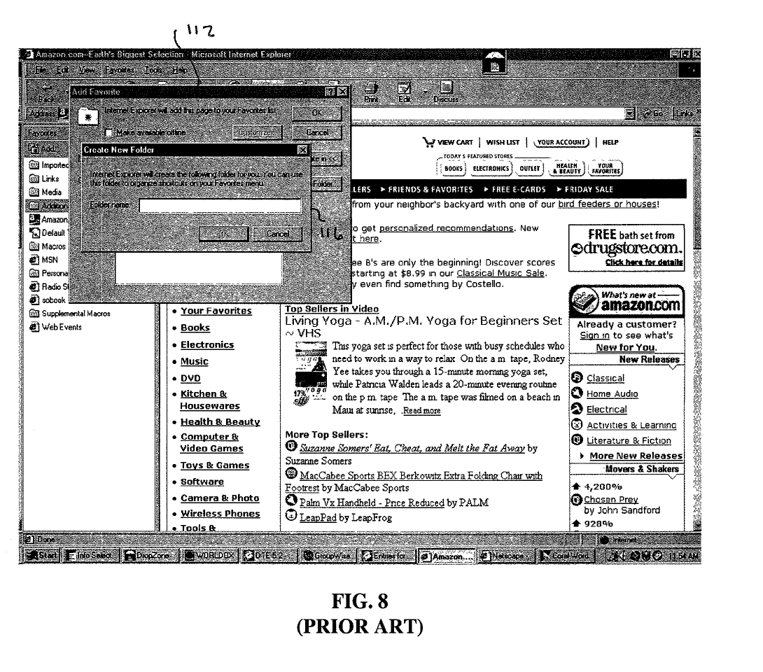

FIG. 9 shows the prior art web browser screen of FIG. 5 with the “Organize . . .” button activated to invoke an organizational popup dialog box;

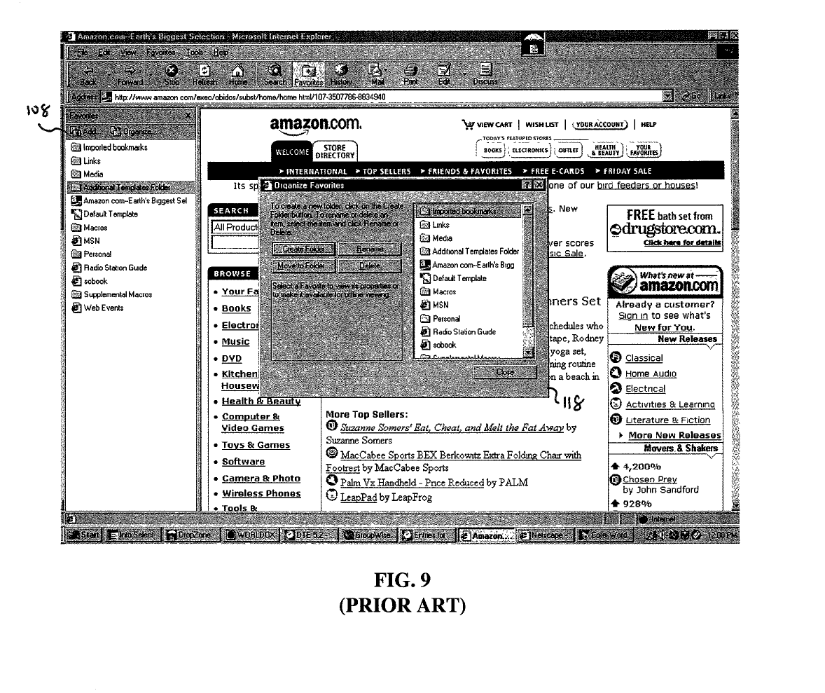

FIG. 10 shows the prior art web browser screen of FIG. 4 with a new retailer web site added to the Favorites list;

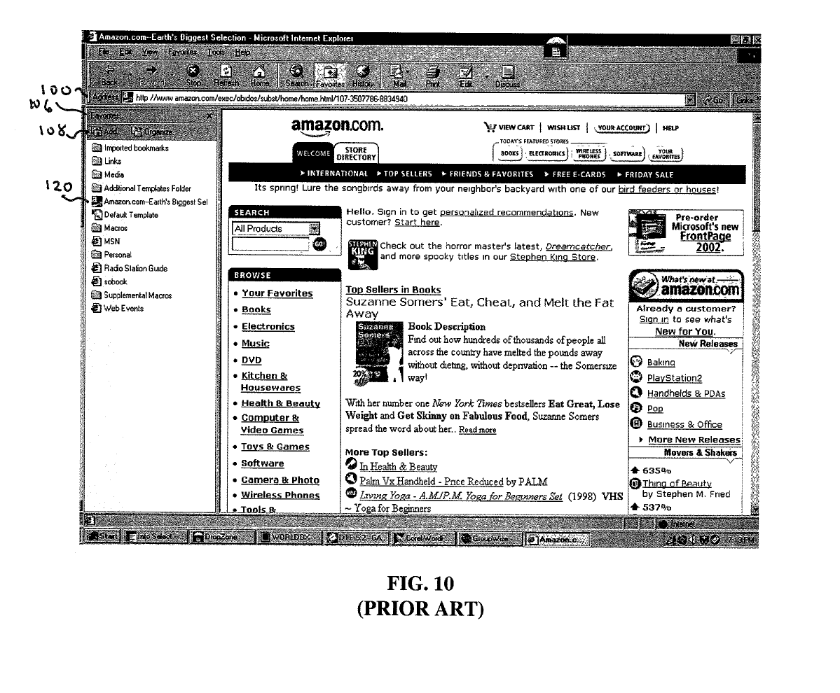

FIG. 11 shows the prior art web browser screen of FIG. 4 with the History button activated to show the History window invoked.;

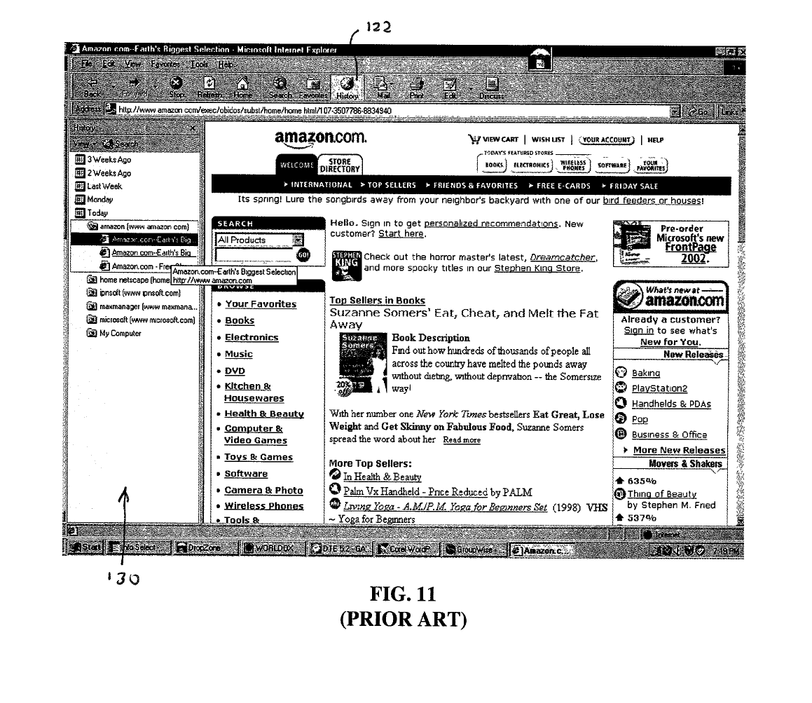

FIG. 12 is a flow chart showing the operation of the present invention;

FIG. 13 shows the web browser screen of the present invention with Favorites created and maintained according to the present invention; and

FIG. 14 shows the web browser screen of the present invention with Favorites automatically categorized into folders.

### DESCRIPTION OF AN ILLUSTRATIVE EMBODIMENT OF THE INVENTION

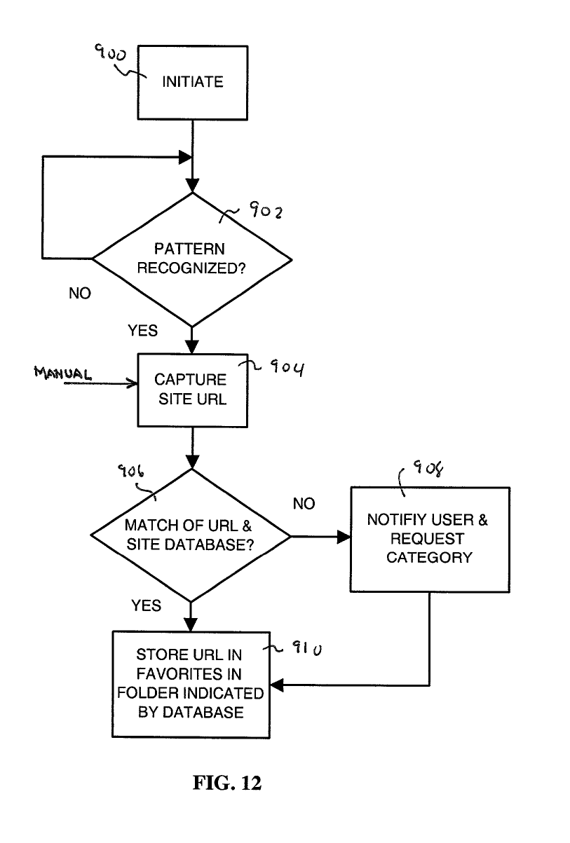

FIG. 12 is a flowchart of the operation of the software according to the present invention. At step 900 the software is initiated when the browser is invoked. In step 902 the software looks for a pattern of action while the browser is in use. If the pattern is not recognized it continues in a loop. This pattern may be the URL, typical screen text, web page HTML source code, or mouse operations that occur when a purchase is being made. However, it can be any other desired activity which the user or programmer wishes to associate with a need to recall the site at some later time. Information about activities which indicate, e.g., a purchase at particular websites, can be stored in a database and compared to the current URL and activities to determine if a recognized pattern has occurred. For example, a visit by the user to a merchant web site can be considered sufficient to indicate that the user has an interest in future shopping visits to that site. The software can detect such a visit to a site even without invocation of the purchase determination form. Therefore, according to the present invention the site will, upon the user's visit to the site, automatically be inserted in the Favorites list under the category or folder containing merchant sites of interest to the user.

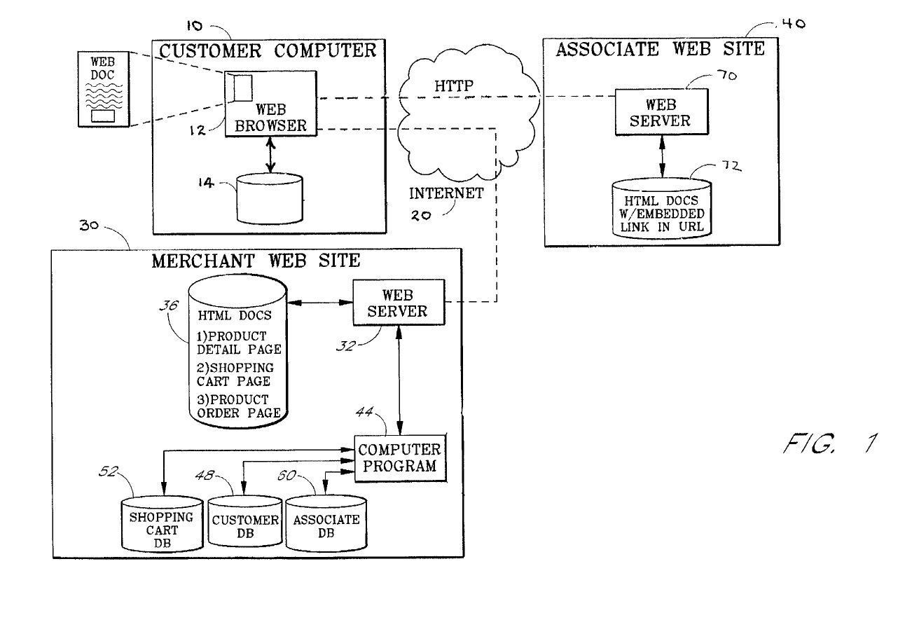

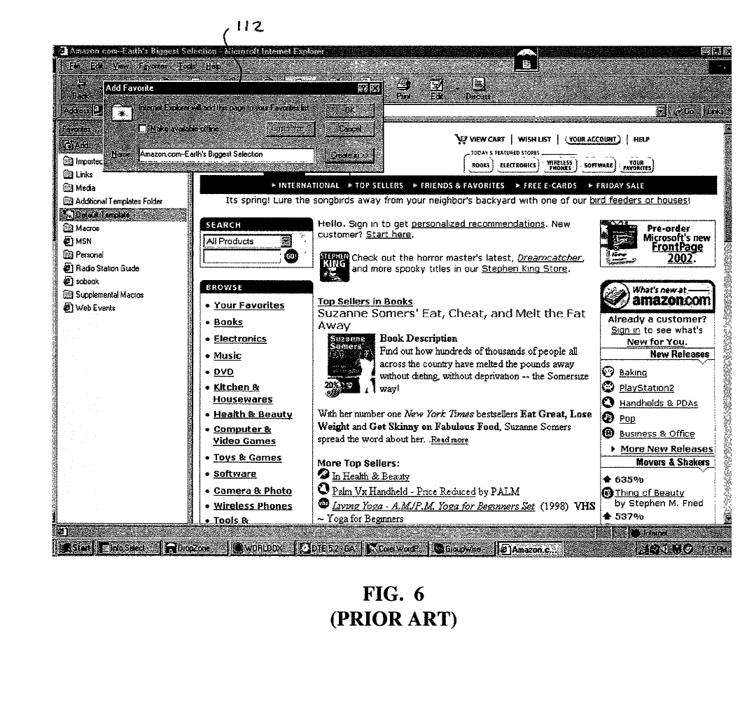

Once the pattern is recognized, a bookmark indication is created, in response to which the program moves to step 904 in which the URL of the site is captured. Also, an identifying title like that shown in FIG. 6 may also be captured. If the pattern is not recognized and/or the URL is not in the database, the user can manually invoke capture of the URL. As an option or an additional feature, in step 906 the URL may be compared to a database of information stored in memory 14 of the user's computer 10 (FIG. 1). This information is periodically downloaded to the user's computer from the organization maintaining the favorites building software. It indicates participating sites and the Favorites category to which the site belongs.

Then in step 906 a determination is made as to whether or not the URL matches any of the category data in the database. If the answer is yes, the category selection is taken and then in step 910 the URL is stored in the Favorites portion of the browser under the category or folder selected from the database. If there is no match, the program moves to step 908 in which a dialogue box is presented to the user. The user then fills in a category or picks from a list of categories available. When this has been completed, the program continues to step 910 where the URL is stored in the database for the browser under the favorites.

Since the user will visit many sites of a particular category over time, in the preferred embodiment of the invention there is a mechanism for preventing the list of sites in any category from growing too large for easy access by the user. One way to implement this is to set a maximum number of sites per category, and have the software automatically discard the oldest (least-recently-accessed) site from a category when that number is exceeded. Another way is to have the software provide some user interface whereby the user can indicate which sites are of greatest interest, allowing the software to automatically discard other sites as the list grows too long.

During the process of selecting an item to purchase, shoppers typically want to visit multiple sites where that type of item is available, to collect information and do comparison shopping. Users like to be informed of sites they were not aware of, if these sites are relevant to the user's current task. Therefore, the present invention includes the capability of presenting the user with site recommendations in conjunction with the list of sites they have visited in a given category. For example, if the user is viewing the automatically-generated list of bookmarks to music merchants, there can also be a set of recommended music merchants presented along with the bookmarks. In the preferred embodiment of the invention, the recommended sites are visually differentiated from sites that the user has actually visited, for example by use of a different icon in the bookmark. As a business model, the distributor of the software may sell the rights to be listed as alternative selections to companies that maintain relevant websites.

The categorization scheme can also be arranged whereby a single site can be filed under multiple categories or folders. As an example, a site related to both books and music could be filed under each of those categories. This can be automatic, by means of a double listing in the database that supports the system

A particular embodiment of the flow chart of FIG. 12 can be implemented using the MaxManager software referred above and described in copending U.S. provisional application No. 60/206,552.

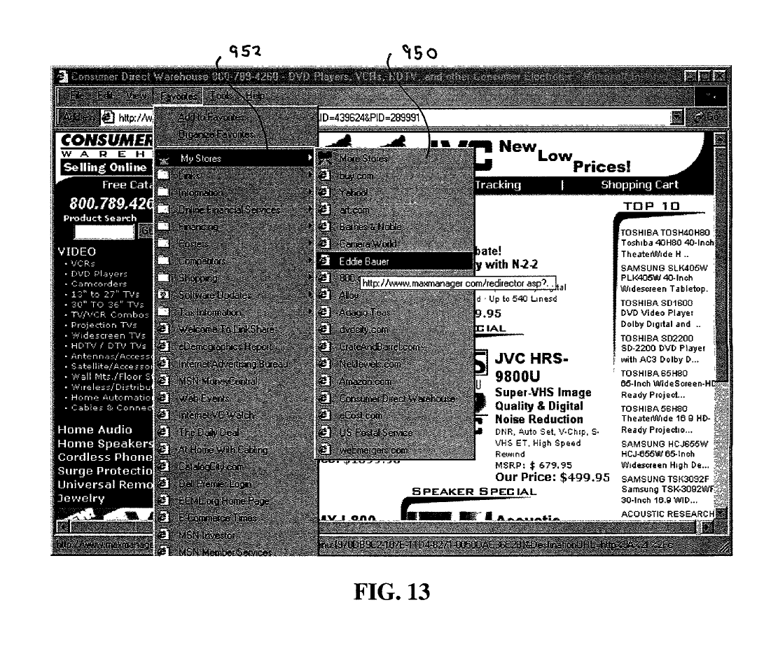

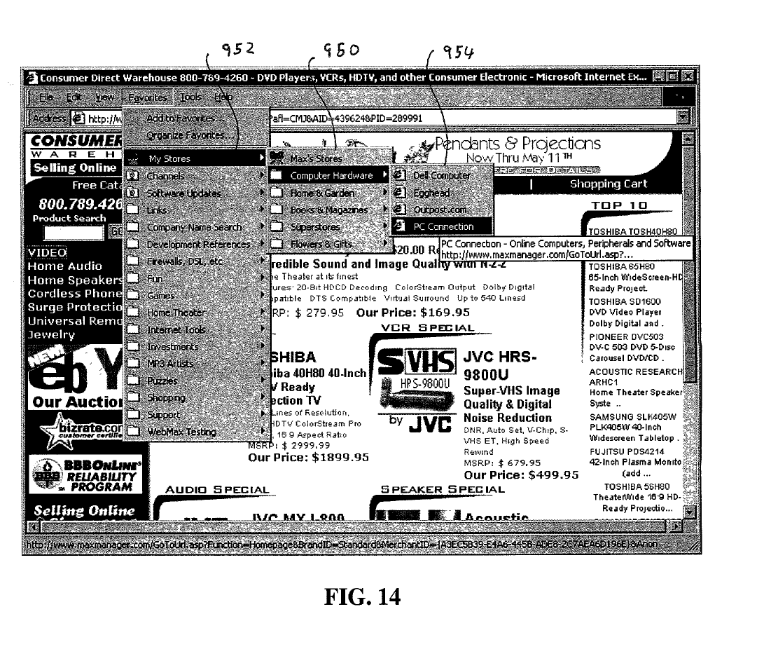

When the browser is started subsequently, and Favorites is clicked on, a list of the links which the browser was originally provided with will appear. Further, any links which were added under the “Favorites” using the browser in the conventional fashion will also appear. However, if for example, as shown in FIG. 13, the line entitled “My Stores” 952 is highlighted, the categories automatically created by the browser will appear in a side box 950. If no categorization has been provided, then simply the last 15 websites visited will be displayed (if 15 has been chosen as the maximum number of sites in a category), with the most frequently visited at the top to the least most frequently visited site. This is shown in FIG. 13. However, in the situation where the categories are listed, when “my stores” is clicked on, the cursor can be moved over the categories and additional side boxes 954 will appear showing the websites in each category. This is shown in FIG. 14. In either case the sites can be arranged alphabetically, or they can be arranged in the order in which they were most frequently visited, or in the order most recently visited, or any other convenient order that may occur to the user.

Thus, a very simple mechanism is provided by which the user can return to websites that had been visited in the past. In large measure, the recording of these websites occurs automatically and even the categorization of these sites can occur automatically.

As shown in FIG. 1, retail websites often have affiliate relationships. The details of an exemplary associate system are described in U.S. Pat. No. 6,029,141, which is incorporated by reference in its entirety. Any customer directed from one website to the retail website and who makes a purchase will cause the originating website to receive a credit, for example, 5% of the sales price. The forwarding website is identified by a code which is in the transferring URL. According to an additional aspect of the present invention, when the Favorites are stored, they are stored not only with the URL of the site to which they refer, but with the affiliate identification of the company providing the Favorites software. (The affiliate identification scheme may be provided directly by the retail website, or by a third party “affiliate network” that operates its own website and redirects the user's browser to the retail website.) Thus, as a business model, the distribution of the software enhances the value of common web browsers by automatically creating an categorizing Favorites lists. However, it also generates income to the distributor of the software by embedding in that software the distributor's affiliate ID in the URLs stored as Favorites.

Alternatively, in an embodiment of the invention, the Favorites may be stored with the URL of a page on a web site operated by the company providing the Favorites software. That page may log this activity to the company's database and then perform a redirection of the user's browser to the target web site that is the user's intended destination. This redirection typically occurs so quickly that the user is not delayed or distracted by it. This technique provides a means of tracking the popularity of particular sites, as well as the Favorites feature in general. This technique may also be combined with the income-generating affiliate technique described above.

While the invention has been particularly shown and described with reference to preferred embodiments thereof, it will be understood by those skilled in the art that various changes in form and detail may be made therein without departing from the spirit and scope of the invention.

We claim:

1. A method of automatically creating Favorites in an Internet web browser comprising the steps of:
monitoring the browser and producing a bookmark indication if it is (1) communicating with a web site and (2) it is being used in a predefined pattern of activity at the web site;
capturing the universal resource locator (URL) of the web site in response to the bookmark indication; and
storing the URL in the Favorites list of the browser.

2. The method of automatically creating Favorites in an Internet web browser as claimed in claim 1 wherein an identifying title is also stored with the URL in the Favorites list.

3. The method of automatically creating Favorites in an Internet web browser as claimed in claim 1 further including the steps of:
compiling a database of URLs and categories of information that the URLs are related to;
comparing the captured URL to the database to determine a category; and
storing the URL in the Favorites list in a folder identified with the category.

4. The method of automatically creating Favorites in an Internet web browser as claimed in claim 3 wherein there are at least two categories associated with a single URL and the URL is stored in the Favorites list in both folders identified with the two categories.

5. The method of automatically creating Favorites in an Internet web browser as claimed in claim 1 wherein the URL is stored with an affiliate identification code.

6. The method of automatically creating Favorites in an Internet web browser as claimed in claim 1 where in the web site is the site of a particular type of business.

7. The method of automatically creating Favorites in an Internet web browser as claimed in claim 6 wherein the type of business is a retail merchant.

8. The method of automatically creating Favorites in an Internet web browser as claimed in claim 1 wherein the pattern of activity is that associated with a purchase at the web site.

9. The method of automatically creating Favorites in an Internet web browser as claimed in claim 1 wherein there is a limit on the number of URL that can be stored in any folder, and further including the step of deleting excess URLs.

10. The method of automatically creating Favorities in an Internet web browser as claimed in claim 9 wherein URLs are deleted based on the last visit so that those which have not been visited in the longest time are deleted first.

11. The method of automatically creating Favorities in an Internet web browser as claimed in claim 9 wherein URLs are deleted based on a user indication.

12. The method of automatically creating Favorites in an Internet web browser as claimed in claim 3 wherein a URL in the database may be associated with the URLs of at least one particular category, and wherein the associated URL is displayed to the user in response to the capture of a URL from that category.

13. A method of advertising over the Internet comprising the steps of:
creating a database of URLs and categories of information related to the URLs so as to associated each URL with at least one category of information;
listing in the database in a category an associated URL of at least one web site which has information which is at least similar to the information of the category;
monitoring use of a browser and producing a bookmark indication if it is (1) communicating with a web site and (2) it is being used in a predefined pattern of activity at the web site;
capturing the universal resource locator (URL) of the web site in response to the bookmark indication;
comparing the captured URL to the database;
storing the URL in the Favorites list in a folder identified with the category; and
displaying the associated URL when the book-marked URL is stored.

14. The method of advertising of claim 13 where in the captured URL is stored in the database in return for compensation from the owner of the captured website.

15. The method of advertising of claim 13 where in the associated URL is stored in the database in return for compensation from the owner of the associated website.
